(19) United States
(12) Patent Application Publication
(10) Pub. No.: US 2018/0204462 A1
(43) Pub. Date: Jul. 19, 2018

(54) DEVICE AND METHOD FOR START ASSISTANCE FOR A MOTOR VEHICLE

(71) Applicant: CONTINENTAL AUTOMOTIVE GMBH, Hannover (DE)

(72) Inventor: Victor Tomescu, Mosnita Veche (RO)

(73) Assignee: CONTINENTAL AUTOMOTIVE GMBH, Hannover (DE)

(21) Appl. No.: 15/923,131

(22) Filed: Mar. 16, 2018

Related U.S. Application Data
(63) Continuation of application No. PCT/EP2016/066880, filed on Jul. 15, 2016.

(30) Foreign Application Priority Data
Sep. 18, 2015 (EP) 15465540.1

(51) Int. Cl. G08G 1/16; B60W 40/02; G06K 9/00

(52) U.S. Cl. CPC G08G 1/166; B60W 40/02; B60W 2710/18; B60W 2550/10; G06K 9/00805

(57) ABSTRACT

A system for start assistance for a motor vehicle includes a surroundings detection device, which is configured to detect an image of the surroundings of the motor vehicle. The system also includes a start assistance device, which is configured to determine a movement and/or a position of a pedestrian on the basis of the detected image of the surroundings of the motor vehicle and to determine a starting time for starting the motor vehicle on the basis of the determined movement and/or the determined position of the pedestrian.

### CROSS REFERENCE TO RELATED APPLICATION

This application is a continuation of International application No. PCT/EP2016/066880, filed Jul. 15, 2016, which claims priority to European application No. 15465540.1, filed Sep. 18, 2015, each of which is hereby incorporated by reference.

### TECHNICAL FIELD

The technical field relates generally to start assistants and driver assistance systems for motor vehicles, which assist the motorist when starting. The technical field relates more specifically to a system and a method for start assistance for a motor vehicle.

### BACKGROUND

Driver assistance systems and start assistants for motor vehicles increase the comfort for drivers of motor vehicles when starting. Start assistants for motor vehicles can be linked to an automatic holding function of the motor vehicle. By utilizing an automatic holding function and the start assistants, the service or parking brake system is automatically triggered when the vehicle is at a standstill, in order to prevent unintentional rolling away.

### BRIEF SUMMARY

A first aspect relates to a system for start assistance of a motor vehicle. The system includes a surroundings detection device configured to detect an image of the surroundings of the motor vehicle. The system also includes a start assistance device configured to determine a movement and/or a position of a pedestrian on the basis of the detected image of the surroundings of the motor vehicle and to determine a starting time for starting the motor vehicle on the basis of the determined movement and/or the determined position of the pedestrian.

As such, the system for start assistance for a motor vehicle is configured to avoid a collision with pedestrians when starting.

The device can be configured to maintain a sufficient safety distance to a pedestrian and/or to a group of pedestrians.

The system can advantageously be linked to start assistants and driver assistance systems, which assist the driver when starting.

In doing so, the system for start assistance automatically adjusts the speed and/or the starting time of the motor vehicle to a traffic density prevailing in the surroundings of the motor vehicle or to the presence of pedestrians or other obstacles.

The system and method described herein may advantageously allow a relaxed starting. The system and method described herein may advantageously allow the motor vehicle to start independently, including when there is heavy pedestrian traffic in front of the motor vehicle. The system can receive the data from an optical sensor device or an imaging sensor device arranged, by way of example, behind the radiator grill.

The system can also include further imaging sensors which, by way of example, are mounted between the interior mirror and the front windshield in a housing.

The system can also comprise a signal generator which warns the driver if a pedestrian is too close, that is to say, within a sufficient safety distance from the vehicle. By way of example, the surroundings of the motor vehicle monitored by the sensor can comprise a range of up to 120 m or up to 80 m or up to 40 m from the vehicle. The safety distance can, by way of example, be up to 15 m or up to 10 m or up to 5 m.

According to a further aspect, a method for start assistance for a motor vehicle is provided. The method includes detecting an image of the surroundings of the motor vehicle utilizing a surroundings detection device. The method also includes determining a movement and/or a position of a pedestrian on the basis of the detected image of the surroundings of the motor vehicle utilizing a start assistance device. The method further includes determining a starting time for the starting of the motor vehicle on the basis of the determined movement and/or the determined position of the pedestrian.

In an advantageous embodiment, it is provided that the start assistance device is configured to determine a movement and/or a position of a group of pedestrians on the basis of the detected image of the surroundings of the motor vehicle and on the basis of the determined movement and/or the determined position of the group of pedestrians, to determine the starting time for starting the motor vehicle. The process of starting the motor vehicle can involve an initialization and execution of various procedures of start assistance systems of the motor vehicle.

Furthermore, starting up of the motor vehicle can comprise the starting, i.e., movement of the motor vehicle, or put another way, starting up the motor vehicle can include an acceleration of the motor vehicle.

This advantageously allows not just an individual pedestrian but also a group of pedestrians to be identified and a sufficient safety distance between pedestrians and motor vehicle to be ensured, so that the starting of the motor vehicle can take place safely, that is to say while maintaining the predefined safety distance.

In a further advantageous embodiment, it is provided that the start assistance device is configured to determine a likely route of the motor vehicle within the surroundings of the motor vehicle and to determine a likely path of the pedestrian or the group of pedestrians on the basis of the detected image of the surroundings of the motor vehicle and on the basis of the determined likely route and the determined likely path to determine the starting time for starting the motor vehicle. This advantageously allows a collision avoidance to be provided and collisions or conflicts between pedestrians and the motor vehicle to be avoided.

In a further advantageous embodiment, it is provided that the start assistance device is configured to provide a collision avoidance on the basis of the determined likely route and the likely path.

In a further advantageous embodiment, it is provided that the surroundings detection device includes an optical camera system, an imaging radar system, or an imaging ultrasound system.

This advantageously allows surroundings data and surroundings information to be gathered and automatic pedestrian detection to be provided. Here, the surroundings detection device can be configured to recognize objects in the image and identify pedestrians in the image. By way of example, persons can be captured who are up to 75 m or up to 35 m or up to 25 m away by utilizing image processing or computer-aided image recognition identified as persons or pedestrians.

The surroundings detection device can be configured to recognize movement patterns of pedestrians and thus determine the movement and/or the position of the pedestrian.

The imaging radar system can, by way of example, include a 76-GHz radar unit.

The imaging radar system can, by way of example, be configured to capture stationary objects in the vicinity or in the surroundings of the motor vehicle and to send radar signals and receive backscatter in the frequency range of 24 GHz or 77 GHz. The imaging radar system has, by way of example, an emission angle in the azimuth at +/−80° and in the vertical emission characteristic at approximately +/−20°.

The optical camera system can, by way of example, include a CMOS (complementary metal-oxide-semiconductor) camera.

The described forms and further developments may be combined in any way with one another.

Further possible forms, further developments and implementations of the present invention also comprise combinations not expressly mentioned of features of the present invention described above or in the following in relation to the exemplary embodiments.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic representation of a device for driver assistance for a motor vehicle on the approach to a crosswalk, which is being crossed by a group of pedestrians;

FIG. 2 is a schematic representation of a device for start assistance for a motor vehicle according to a further embodiment of the present invention;

FIG. 3 is a schematic representation of a device for start assistance for a motor vehicle, wherein the motor vehicle is approaching a crosswalk with an individual pedestrian on it;

FIG. 4 is a schematic representation of a device for driver assistance for a motor vehicle according to a further embodiment of the present invention;

FIG. 5 is a schematic representation of a device for start assistance for a motor vehicle according to a further embodiment of the present invention; and

FIG. 6 is a schematic representation of a device for start assistance according to a further embodiment of the present invention.

### DETAILED DESCRIPTION

Referring to the Figures, wherein like numerals indicate like parts throughout the several views, a system for driver assistance of a motor vehicle 100 is shown and described herein.

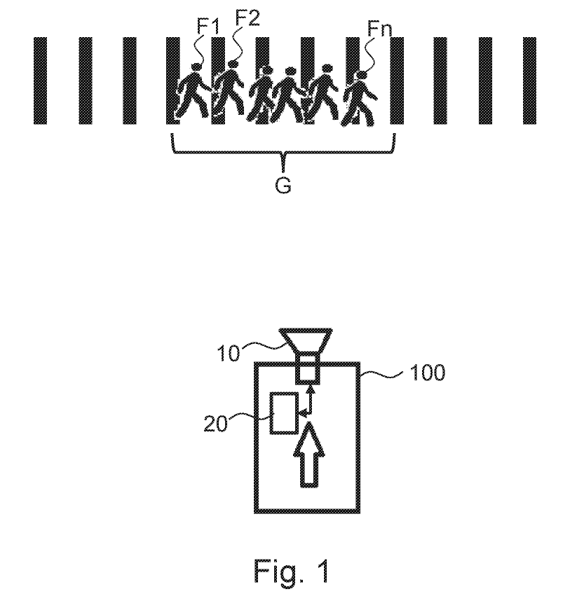

FIG. 1 is a schematic representation of the system for driver assistance for a motor vehicle according to one embodiment. The system 100 includes, by way of example, a surroundings detection device 10 and a start assistance device 20.

In the example shown in FIG. 1, a group G of pedestrians F1, F2, . . . , Fn, is in the process of crossing a crosswalk. This crossing of the crosswalk undertaken by the pedestrians F1, F2, . . . , Fn, is captured by the surroundings detection device 10.

The surroundings detection device 10 can, by way of example, record an image in the form of an optical camera image or a radar image or in the form of an ultrasound image of the surroundings, in which the pedestrians F1, F2, . . . , Fn, are depicted crossing the crosswalk in the surroundings of the motor vehicle.

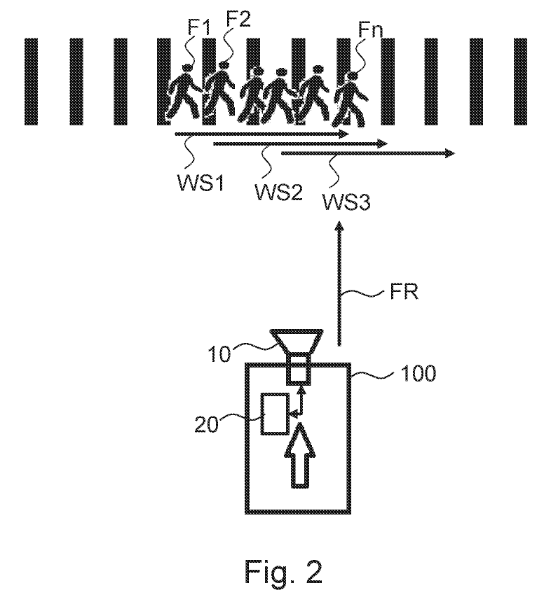

FIG. 2 is a schematic representation of the system 100 for start assistance for a motor vehicle according to a further embodiment. In the embodiment shown in FIG. 2, the motor vehicle has been assigned a likely route FR by the start assistance device 20.

Furthermore, in this example, a plurality of likely paths are assigned by the start assistance device 20, by way of example a first path WS1, a second path WS2, and a third path WS3, to individual pedestrians F1, F2, . . . , Fn, from the group of pedestrians F1, F2, . . . , Fn, wherein the pedestrians F1, F2, . . . , Fn, are crossing the crosswalk.

The start assistance device 20 may determine possible points of intersection between the route FR of the motor vehicle and the paths WS1, WS2, WS3 of the pedestrians.

In the present case, the start assistance device 20 determines intersection or crossing points between the routes and the paths and consequently postponed a starting time for starting the motor vehicle.

The other reference numerals, as shown in FIG. 2, have already been described in the description of the figures for FIG. 1 above and are not described again here.

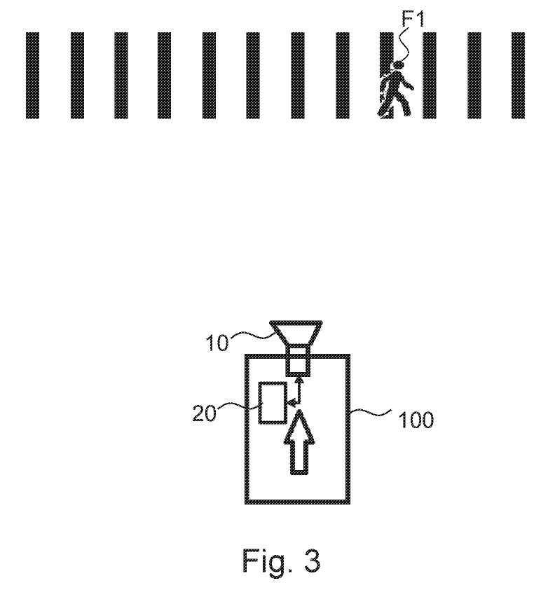

FIG. 3 is a schematic representation of the system 100 for start assistance for a motor vehicle. In the embodiment shown in FIG. 3 there is just one pedestrian F1 in the crosswalk. Furthermore, the pedestrian F1 on the crosswalk has already almost completely finished crossing the crosswalk.

As such, the start assistance device 20 may determine that the motor vehicle is still sufficiently far away from the crosswalk—by way of example, 12 m—and thus a starting time for starting the motor vehicle can be specified, without a sufficient safety distance—by way of example, 8 m—between vehicle and pedestrian F1 being breached.

The other reference numerals, as shown in FIG. 3, have already been described in the description of the figures for the above figures and are not described again here.

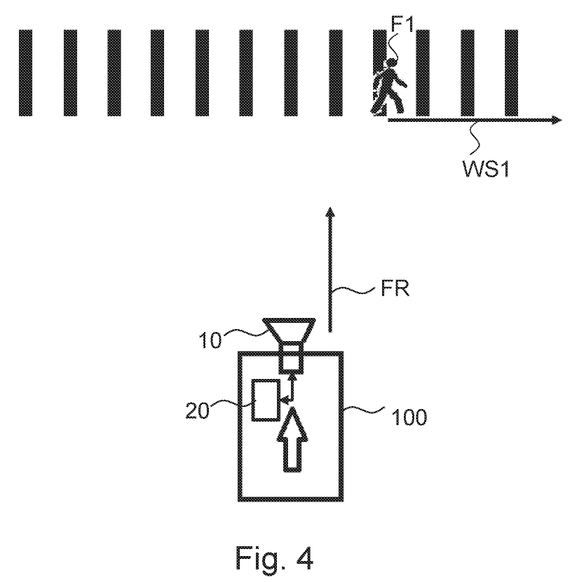

FIG. 4 is a schematic representation of the system 100 for start assistance for a motor vehicle. In this embodiment, the start assistance device 20 determines a route FR of the motor vehicle. Furthermore, the start assistance device 20 also determines a path WS1 for the pedestrian F1 present on the crosswalk.

Furthermore, on the basis of the determined path WS1 and on the basis of the determined likely route FR, the start assistance device 20 determines a starting time for starting the motor vehicle.

The other reference numerals, as shown in FIG. 4, have already been described in the description of the figures for the above figures and are not described again here.

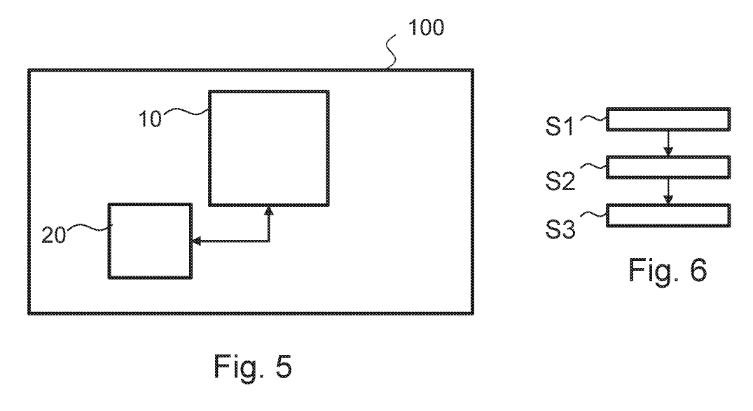

FIG. 5 is a schematic representation of the system 100 for start assistance for a motor vehicle according to a further embodiment. The surroundings detection device 10 is, by way of example, designed to capture an image of the surroundings of the motor vehicle. The surroundings detection device 10 is, by way of example, configured as an optical camera system, as an imaging radar system, or as an imaging ultrasound system.

Furthermore, the surroundings detection device 10 can be configured as a combination of an optical camera system and/or an imaging radar system and/or an imaging ultrasound system.

The start assistance device 20 is, by way of example, configured to determine a movement and/or a position of a pedestrian F1, F2, . . . , Fn, on the basis of the captured image of the surroundings of the motor vehicle and on the basis of the determined movement and/or the determined position of the pedestrian F1, F2, . . . , Fn, to determine a starting time for starting the motor vehicle.

The start assistance device 20 is, by way of example, configured to determine a movement and/or a position of a group G of pedestrians F1, F2, . . . , Fn, on the basis of the detected image of the surroundings of the motor vehicle and on the basis of the determined movement and/or the determined position of the group G of pedestrians F1, F2, . . . , Fn, to determine the starting time for starting the motor vehicle.

FIG. 6 is a schematic representation of a method for start assistance for a motor vehicle according to one embodiment. The method for start assistance comprises, by way of example, at S 1, detecting the surroundings of the motor vehicle in the image utilizing the surroundings detection device 10.

The method may also include, by way of example, at S2, ascertaining a movement and/or a position of a pedestrian F1, F2, . . . , Fn, on the basis of the detected image of the surroundings of the motor vehicle with the help of a start assistance device 20.

As a third step of the method, by way of example, a starting time for starting the motor vehicle is determined S3 on the basis of the determined movement and/or the determined position of the pedestrian.

Although the present invention has been described above on the basis of exemplary embodiments, it is not restricted to these, but is modifiable in multiple ways. In particular, the present invention is changeable or modifiable in many ways without deviating from the essence of the invention.

Mention is also made of the fact that the terms “comprising”, “including”, and “having” do not exclude any other elements or steps and the singular “a” does not exclude a plurality.

Mention is also made of the fact that features or steps, described by reference to one of the above exemplary embodiments, can also be used in combination with other features or steps of other exemplary embodiments described above. Reference numerals in the claims are not to be considered as restrictions.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A system for start assistance for a motor vehicle, wherein the system comprises:
a surroundings detection device configured to detect an image of the surroundings of the motor vehicle; and
a start assistance device configured to determine a movement and/or a position of a pedestrian on the basis of the detected image of the surroundings of the motor vehicle and to determine a starting time for starting the motor vehicle on the basis of the determined movement and/or the determined position of the pedestrian.

2. The system of claim 1, wherein the start assistance device is configured to determine a movement and/or a position of a group of pedestrians on the basis of the detected image of the surroundings of the motor vehicle and to determine the starting time for starting the motor vehicle on the basis of the determined movement and/or the determined position of the group of pedestrians.

3. The system of claim 1, wherein the start assistance device is configured to determine a likely route of the motor vehicle within the surroundings of the motor vehicle and to determine a likely path of the pedestrian or the group of pedestrians on the basis of the detected image of the surroundings of the motor vehicle and on the basis of the determined likely route and the determined likely path to determine the starting time for starting the motor vehicle.

4. The system of claim 3, wherein the start assistance device is configured to provide a collision avoidance on the basis of the determined likely route and the likely path.

5. The system of claim 1, wherein the surroundings detection device comprises at least one of an optical camera system, an imaging radar system, and an imaging ultrasound system.

6. A motor vehicle, comprising:
a system for start assistance for a motor vehicle, wherein the system comprises
a surroundings detection device configured to detect an image of the surroundings of the motor vehicle, and
a start assistance device configured to determine a movement and/or a position of a pedestrian on the basis of the detected image of the surroundings of the motor vehicle and to determine a starting time for starting the motor vehicle on the basis of the determined movement and/or the determined position of the pedestrian.

7. A method for start assistance for a motor vehicle, wherein the method comprises:
capturing an image of the surroundings of the motor vehicle utilizing a surroundings detection device;
determining a movement and/or a position of a pedestrian on the basis of the detected image of the surroundings of the motor vehicle utilizing a start assistance device; and
determining a starting time for starting the motor vehicle on the basis of the determined movement and/or the determined position of the pedestrian.

8. The method of claim 7, further comprising:
determining a movement and/or a position of a group of pedestrians on the basis of the detected image of the surroundings of the motor vehicle; and
determining the starting time for starting the motor vehicle on the basis of the determined movement and/or the determined position of the group of pedestrians.

9. The method of claim 7, further comprising:
determining a likely route of the motor vehicle within the surroundings of the motor vehicle on the basis of the detected image of the surroundings of the motor vehicle;
determining a likely path of the pedestrian or the group of pedestrians on the basis of the detected image of the surroundings of the motor vehicle; and
determining the starting time for starting the motor vehicle on the basis of the determined likely route and the likely path.

10. The method of claim 9, further comprising providing a collision avoidance on the basis of the determined likely route and the likely path.
